(19) United States
(12) Patent Application Publication
(10) Pub. No.: US 2022/0212440 A1
(43) Pub. Date: Jul. 7, 2022

(54) COMPOSITE BOARD

(71) Applicant: Markus BARD, Reinach (CH)

(72) Inventor: Markus BARD, Reinach (CH)

(21) Appl. No.: 17/609,735

(22) PCT Filed: Apr. 23, 2020
(86) PCT No.: PCT/EP2020/061397

§ 371 Date: Nov. 8, 2021

(30) Foreign Application Priority Data
Apr. 25, 2019 (CH) 00553/19

(51) Int. Cl. B32B 5/16; B32B 3/18; B32B 7/03; B32B 9/02; B32B 9/04; B32B 15/16; B32B 15/20; B32B 29/04; B32B 29/06

(52) U.S. Cl. CPC B32B 5/16; B32B 2607/00; B32B 7/03; B32B 9/02; B32B 9/048; B32B 9/041; B32B 9/045; B32B 15/16; B32B 15/20; B32B 29/04; B32B 29/06; B32B 2250/05; B32B 2260/025; B32B 2260/046; B32B 2264/065; B32B 3/18

(57) ABSTRACT

The particle board consists of a middle layer (1) made from bamboo strands (2) and two adjoining fine layers (3, 4) made from glued bamboo shavings or chips, as well as cover layers on both sides (5, 6).

The invention relates to a composite board with a plurality of middle layers of different bamboo material and two cover layers, as well as a method for its manufacture.

Multilayered composite boards with middle layers of bamboo to reduce the weight are known. The coarse middle layers made from long-fibered bamboo strands have a large number of hollow spaces, which are desirable in order to achieve a low weight of the board, and which should not be filled with glue or a glue-fiber mixture during the manufacturing process.

The invention is therefore based on the task of creating a composite board and a method for its manufacture in which the hollow spaces of the long-fibered middle layer are largely empty.

According to the invention, this is achieved by the characterizing features of claim 1 and the method claim.

According to a preferred embodiment of the invention, the middle layer consists of long-fibered bamboo strands that are laid crosswise, with the layers adjoining on both sides consisting of glued fine bamboo shavings or chips. This ensures that the surfaces to which thin cover layers are applied are particularly smooth.

Below, preferred embodiments of the invention are described with reference to the accompanying drawings.

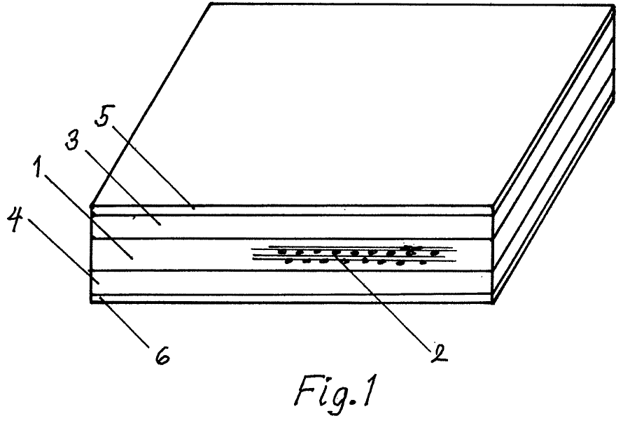

FIG. 1 is a schematic perspective view of a composite board with a middle layer.

The composite board shown in FIG. 1 consists of five layers, namely a middle layer 1 made from bamboo strands 2 which are arranged crosswise and two fine layers 3, 4 made from glued bamboo shavings or chips adjoining on both sides. With these two fine layers, a particularly finely structured or smooth surface can be achieved, onto which the cover layers 5, 6 made from different materials, such as lacquering, coating with resins or resin-soaked papers, linoleum, synthetic resin or aluminum can be applied.

It is particularly important in this regard that the material of the fine layers does not get into the hollow spaces, because this would make the board heavier. The coarse chips are smoothed off and then the fine layer is applied.

Fire protection boards and fire protection elements can be produced with special glue mixtures and additives such as gypsum or other non-combustible materials.

Waterproof boards can be made for damp or wet areas, for floors in bathrooms or in construction with other special glue mixtures.

A formaldehyde-free eco-board can be produced with another special glue, e.g., PVA glue. It is possible to produce a board that is very light and stable with additives, such as Styrofoam, balsa wood or poplar chips.

Special boards with the highest stability are produced with a very high compaction for the absolutely most stable version with a denser filling and higher pressing force.

The boards are manufactured via a one-step compression of all layers. On a belt, the layer arrangement is fed to a press where the layers are pressed together.

1. A composite board comprising a plurality of middle layers of different bamboo material and two cover layers.

2. The composite board according to claim 1, which contains three layers including each of a middle layer made bamboo strands that are arranged crosswise in the middle layer, and two fine layers, made from glued bamboo shavings or chips, adjoining on each of two opposite major sides of the middle layer.

3. The composite board according to claim 2, wherein each of the two fine layers possess a smooth surface on a major side thereof that is opposite to the middle layer.

4. The composite board according to claim 2, which further comprises a pair of cover layers that cover the two fine layers on a major side of each of the fine layers that is opposite to the middle layer.

5. The composite board according to claim 4, wherein each of the cover layers optionally contains lacquering, resins, resin-soaked papers, linoleum, synthetic resin or aluminum.

6. A composite board, which contains:
three layers including each of a middle layer made bamboo strands that are arranged crosswise in the middle layer, and two fine layers, made from glued bamboo shavings or chips, adjoining on each of two opposite major sides of the middle layer, and
a pair of cover layers that cover the two fine layers on a major side of each of the fine layers that is opposite to the middle layer; and
wherein each of the two fine layers possess a smooth surface on the major side thereof that is opposite to the middle layer.
